(19) United States
(12) Patent Application Publication
(10) Pub. No.: US 2015/0233532 A1
(43) Pub. Date: Aug. 20, 2015

(54) LIGHT SOURCE DEVICE

(71) Applicant: SHARP KABUSHIKI KAISHA, Osaka-shi, Osaka (JP)

(72) Inventor: Noriaki Terazawa, Osaka-shi (JP)

(73) Assignee: SHARP KABUSHIKI KAISHA, Osaka-shi, Osaka (JP)

(21) Appl. No.: 14/426,078

(22) PCT Filed: Aug. 13, 2013
(86) PCT No.: PCT/JP2013/071852

§ 371 Date: Mar. 4, 2015

(30) Foreign Application Priority Data
Sep. 28, 2012 (JP) 2012-218179

(51) Int. Cl. F21K 99/00; F21V 19/00

(52) U.S. Cl. CPC F21K 9/175; F21K 9/50; F21V 19/003; F21Y 2103/003

(57) ABSTRACT

A substrate with a light source mounted on one surface thereof, a placing plate, and a support part which supports the placing plate are disposed inside of a translucent cover at a position biased from a center side of the translucent cover to an inner surface side of the translucent cover. In addition, the substrate is disposed in such a manner that the light source is directed to the center side of the translucent cover. Further, a placing part of the placing plate on which the substrate is placed is disposed on the center side of the translucent cover from side parts of the placing plate supported by the support part.

### CROSS-REFERENCE TO RELATED APPLICATIONS

This application is the national phase under 35 U. S. C. §371 of PCT International Application No. PCT/JP2013/071852 which has an International filing date of Aug. 13, 2013 and designated the United States of America.

### FIELD

The present invention relates to a light source device which includes a substrate with a light source mounted thereon, a placing plate on which the substrate is placed, and a cylindrical translucent cover in which the substrate and the placing plate are disposed.

### BACKGROUND

Recently, with the higher brightness of a light emitting diode (LED), instead of a light source such as incandescent bulbs, fluorescent lamps, or the like, LEDs having characteristics such as a low consumption power, a long life, or the like have become to be used in a lighting device and the like as the light source.

For example, as a substitute for a straight tube type fluorescent lamp, a straight tube type LED (light source device), in which white LEDs are mounted on a substrate, and the substrate is covered with a cylindrical translucent cover provided with bases at both ends thereof, has been commercialized.

In addition, an LED lamp, in which a laterally long rectangular-shaped light source substrate and an elongated block-shaped heat dissipation member extending in a longitudinal direction are included in a cylindrical case, is disclosed in the art (see Japanese Patent Application Laid-open No. 2010-123359).

### SUMMARY

However, in the LED lamp disclosed in Japanese Patent Application Laid-open No. 2010-123359, the heat dissipation member is biased from a central axis of the case (translucent cover) to an inner side of the case, and the heat dissipation member is disposed in a state of being closely contacted with the inner surface of the case.

Therefore, if heat generated from the light source substrate or the like is conducted to the heat dissipation member, the temperature of a proximal portion adjacent to the heat dissipation member of the case is higher than that of a portion (for example, a portion on a side opposite to the proximal portion with respect to the central axis of the case) to which the heat dissipation member of the case is not adjacent, and a temperature rise of the case becomes non-uniform, and thereby warping may occur in the case due to a difference in thermal expansion.

In consideration of the above-mentioned circumstances, it is an object of the present invention to provide a light source device which is capable of preventing the warping of a translucent cover.

According to one aspect of the present invention, there is provided a light source device which includes a substrate with a light source mounted thereon, a placing plate on which the substrate is placed, and a cylindrical translucent cover in which the substrate and the placing plate are disposed, the light source device including: a support part which is mounted in the translucent cover, and supports the placing plate so as to provide a gap between the placing plate and the translucent cover, wherein the support part is configured such that a central portion thereof on which the light source is located protrudes in a central direction of the translucent cover with respect to both end parts thereof.

According to another aspect of the present invention, there is provided a light source device which includes a substrate with a light source mounted thereon, a placing plate on which the substrate is placed, and a cylindrical translucent cover in which the substrate and the placing plate are disposed, the light source device including: a support part which is mounted in the translucent cover, and supports the placing plate so as to provide a gap between the placing plate and the translucent cover, wherein the placing plate is supported by the support part so that a placing part for the substrate protrudes in a central direction of the translucent cover with respect to side parts extending from end parts of the placing part.

In the light source device according to the present invention, the placing plate may have a placing part on which the substrate is placed, and side parts which extend from end parts of the placing part, and the support part may support the side parts by both end parts thereof.

In the light source device according to the present invention, the support part may have a curved plate located at an inner side of the translucent cover, and a partition plate which separates a space between the curved plate and the placing plate.

In the light source device according to the present invention, the translucent cover may include a protrusion disposed on an inner surface thereof in a longitudinal direction of the translucent cover, and the curved plate may have a fitting hole to which the protrusion is fitted.

According to the present invention, it is possible to prevent the warping of a translucent cover.

The above and further objects and features will more fully be apparent from the following detailed description with accompanying drawings.

### BRIEF DESCRIPTION OF THE DRAWINGS

FIG. 1 is a plan view illustrating an example of an exterior of a light source device of Embodiment 1.

FIG. 2 is a cross-sectional view illustrating an example of a configuration of the light source device of Embodiment 1.

FIG. 3 is a plan view illustrating an example of a configuration of a substrate of Embodiment 1.

FIG. 4 is a cross-sectional view of a placing plate of Embodiment 1.

FIG. 5 is a plan view of the placing plate of Embodiment 1.

FIG. 6 is a cross-sectional view illustrating an example of a configuration of a support part of Embodiment 1.

FIG. 7 is a plan view illustrating the example of the configuration of the support part of Embodiment 1.

FIG. 8 is a bottom view illustrating the example of the configuration of the support part of Embodiment 1.

FIG. 9 is a cross-sectional view illustrating an example of a configuration of a light source device of Embodiment 2.

FIG. 10 is a cross-sectional view illustrating an example of a configuration of a light source device of Embodiment 3.

FIG. 11 is a cross-sectional view illustrating an example of a configuration of a light source device of Embodiment 4.

### DETAILED DESCRIPTION

### Embodiment 1

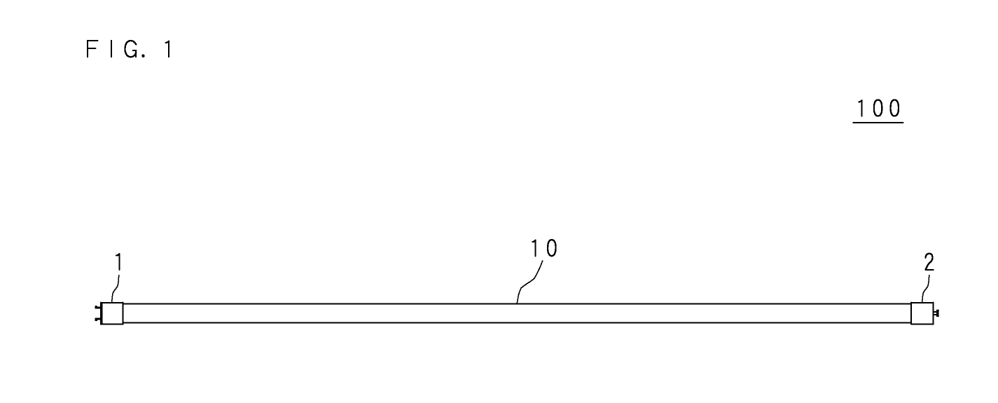

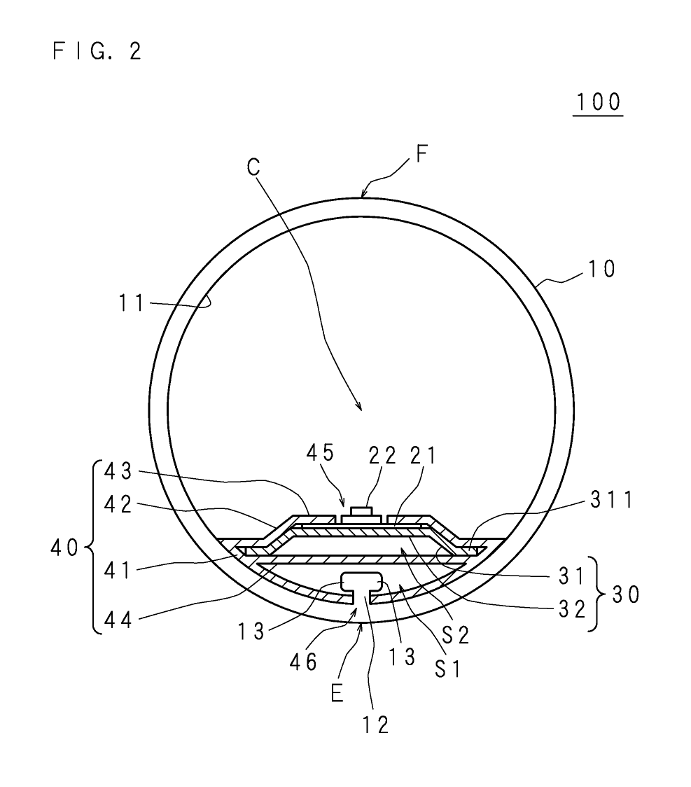

Hereinafter, embodiments of the present invention will be described with reference to the accompanying drawings illustrating the embodiments thereof. FIG. 1 is a plan view illustrating an example of an exterior of a light source device 100 of Embodiment 1, and FIG. 2 is a cross-sectional view illustrating an example of a configuration of the light source device 100 of Embodiment 1. The light source device 100 of the present invention is, for example, a straight tube lamp which is a substitute for a conventional 40 W type straight tube fluorescent lamp, and mounted in lamp sockets (not illustrated) provided in a lighting device body (lamp fixture). Further, the wattage (W) is not limited to 40 W, and other wattage such as 20 W, 100 W, or the like may be used.

The light source device 100 is provided with bases 1 and 2 at both ends thereof, and includes a cylindrical translucent cover 10. The translucent cover 10 includes a substrate, a placing plate, a support part, and the like inside thereof, which will be described below.

The translucent cover 10 is made of a synthetic resin which is superior in weatherability and transparency and has high extraction efficiency of light, and for example, polycarbonate can be used. The translucent cover 10 (polycarbonate) has a coefficient of thermal expansion of 70 ppm/degree, for example.

As illustrated in FIG. 2, a substrate 21 with a light source 22 mounted on one surface thereof, a placing plate 30, and a support part 40 which supports the placing plate 30 are disposed inside of the translucent cover 10 at a position biased from a center side C of the translucent cover 10 (for example, it may be the central axis of the translucent cover 10) to an inner surface 11 side of the translucent cover 10. Further, in the following embodiments, the center side C of the translucent cover 10 means not only a central axis of the translucent cover 10, but also the vicinity of the central axis (for example, a space surrounded by a diameter of about half of the inner diameter of the translucent cover 10).

In addition, the substrate 21 is disposed in such a manner that an emission direction of the light source 22 is directed to the center side C of the translucent cover 10. That is, the substrate 21 is disposed in such a manner that one surface of the substrate 21 on which the light source 22 is mounted is directed to the center side C of the translucent cover 10.

The translucent cover 10 includes a protrusion 12 disposed on the inner surface 11 thereof in a longitudinal direction of the translucent cover 10. The protrusion 12 is provided with narrow portions 13 widely formed at an end portion thereof. The protrusion 12 has a cross-section shape formed in a substantially T shape.

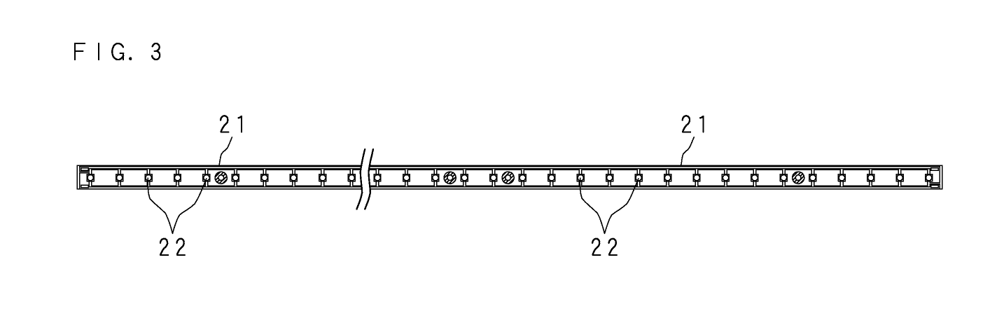

FIG. 3 is a plan view illustrating an example of a configuration of the substrate 21 of Embodiment 1. FIG. 3 illustrates a state as seen from the one surface of the substrate 21, that is, the surface on which the light sources (LED modules) 22 are mounted. The substrate 21 is formed in a rectangular shape, and a plurality of light sources 22 are mounted on a center of the substrate 21 in a row. A material of the substrate 21 may be aluminum, and the substrate 21 made of a resin may be used. Further, the arrangement of the light sources 22 on the substrate 21 is not limited to the example of FIG. 3, and for example, the light sources 22 may be mounted on the substrate 21 by arranging in two rows, three rows, or the like along the longitudinal direction thereof. In addition, a plurality of substrates 21 may be disposed in the longitudinal direction depending on the length of the translucent cover 10. Herein, the light source 22 may be a white LED module, and for example, can emit daylight tone light.

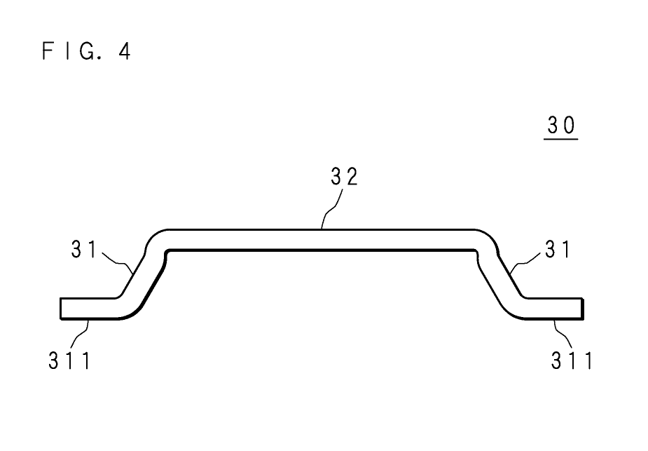

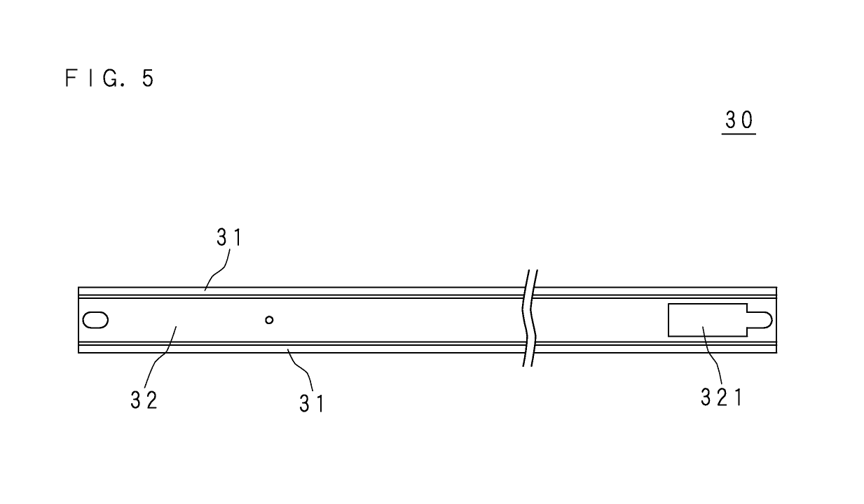

FIG. 4 is a cross-sectional view of a placing plate 30 of Embodiment 1, and FIG. 5 is a plan view of the placing plate 30 of Embodiment 1. FIG. 5 illustrates a state as seen from a placing surface side on which the substrate 21 is placed. As illustrated in FIGS. 4 and 5, the placing plate 30 is, for example, a plate member made of metal such as aluminum or iron, and functions as a heat conductive plate. A material forming the placing plate 30 is not limited to the material made of the metal, and may be made of other material with excellent heat conductivity such as a ceramic or the like. Heat from the light source 22 (LED module) is conducted to the placing plate 30. In addition, the placing plate 30 includes a placing part 32 on which the substrate 21 is placed, and side plates 31 slantly extending from long sides of the placing part 32. That is, the side plates 31 are side parts of the long sides of the placing plate 30. Further, in the example of FIGS. 4 and 5, the side plates 31 extend from the both long sides of the placing part 32 (two side plates 31 are included), but it may be configured that a side plate 31 extends from only one long side of the placing part 32. In this case, one side plate 31 is included. Further, the side plate 31 may have a shape which is bent perpendicularly from the end portion of the placing part 32 without inclining with respect to the placing part 32.

The placing plate 30 is formed in a rectangular shape. The length of the placing part 32 is equal to that of the substrate 21 (in case of a plurality of substrates 21, a sum of the length of the plurality of substrates 21), and the width of the placing part 32 is slightly wider than that of the substrate 21.

The side plates 31 have bent parts 311 formed at an edge part thereof by bending so as to be substantially parallel to the placing part 32. The bent parts 311 form a portion of the side parts of the placing plate 30. Further, as illustrated in FIG. 5, a wiring hole 321 for passing through wirings, or the like may be formed at a desired place of the placing part 32.

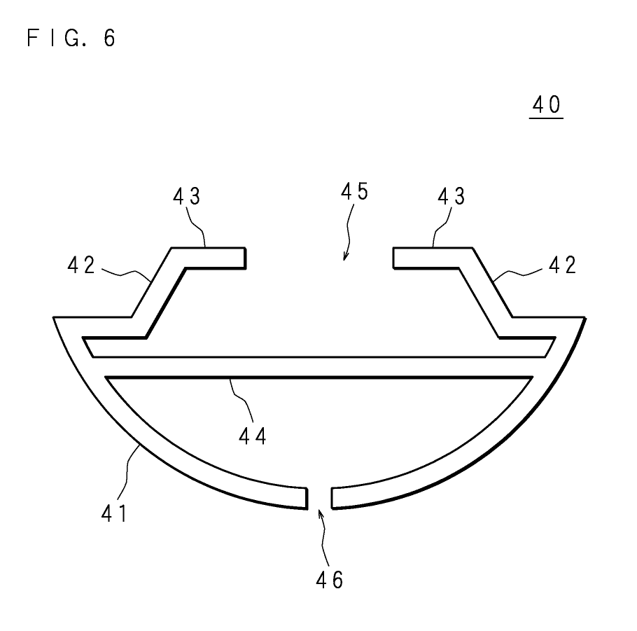

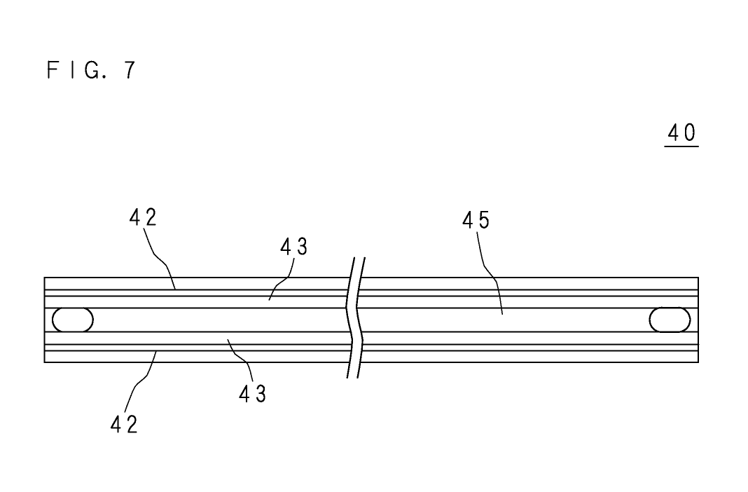

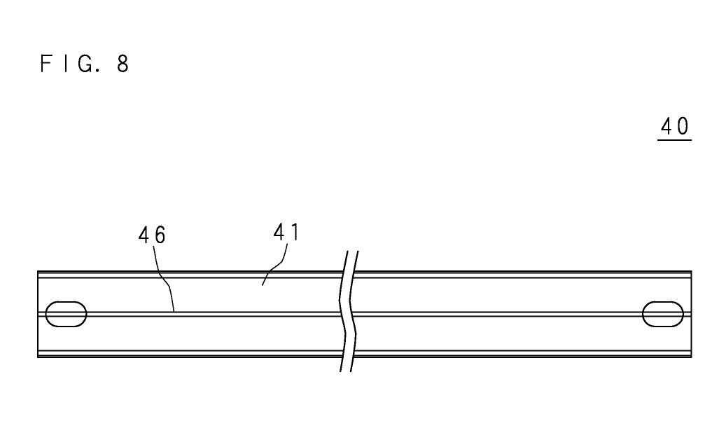

FIG. 6 is a cross-sectional view illustrating an example of a configuration of the support part 40 of Embodiment 1, FIG. 7 is a plan view illustrating the example of the configuration of the support part 40 of Embodiment 1, and FIG. 8 is a bottom view illustrating the example of the configuration of the support part 40 of Embodiment 1. The support part 40 is made of a synthetic resin, and for example, may be made of polybutylene terephthalate (PBT) by extrusion molding. Further, the material of the support part 40 is not limited to PBT, and other material may be used as long as it is easy to mold and has excellent heat resistance. Preferably, the support part 40 is made of a material having low heat conductivity.

The support part 40 has a length and width equal to those of the placing plate 30. The support part 40 includes a curved plate 41 which is located on the inner surface 11 side of the translucent cover 10 to abut the inner surface 11, side plate abutting plates 42 which extend from the curved plate 41 to abut the side plates 31 of the placing plate 30 as both end parts or an end part thereof, fitting plates 43 which extend from the side plate abutting plates 42 to fit the substrate 21 with the placing part 32 of the placing plate 30, and a partition plate 44 which is configured to fit the side plates 31 (specifically, the bent parts 311) of the placing plate 30 with the side plate abutting plates 42. That is, the support part 40 has the curved plate 41 formed by bending along the inner surface 11 of the translucent cover 10, and the support part 40 is mounted in the translucent cover 10, while the curved plate 41 abuts the inner surface 11 of the translucent cover 10.

The fitting plate 43 has an opening 45 formed in the longitudinal direction of the support part 40 to expose the light source 22. The width of the opening 45 has a dimension enough to expose an emitting surface of the light source 22 mounted on the substrate 21 from the fitting plate 43. That is, the central portion in which the light source is located is the fitting plate 43 having the opening 45 for fitting the light source 22, and is configured to protrude in a central direction of the translucent cover 10 with respect to the side plate abutting plates 42 which are both end parts. Further, the central portion in which the light source is located is not limited to the fitting plate 43 having the opening 45, and may have a configuration in which the placing plate is provided in the central portion in which the light source is located. That is, the substrate 21 may be provided on an upper surface of the fitting plate 43 (central portion) which does not have the opening 45. In this case, the opening for fitting the light source 22 is not required. In addition, the shape of the placing plate is not limited, and may have a flat plate shape.

The support part 40 has the curved plate 41 located on the inner side of the translucent cover 10, and the partition plate 44 separating a space between the curved plate 41 and the placing plate 30. The partition plate 44 is bridged between opposite end parts of the curved plate 41. By the partition plate 44, it is possible to separate the space surrounded by the curved plate 41, the side plate abutting plate 42 and the fitting plate 43 into a plurality of spaces (two spaces in this embodiment).

In addition, as illustrated in FIGS. 6 and 8, the curved plate 41 has a fitting hole 46 formed in the center thereof in the longitudinal direction. By fitting the above-described protrusion 12 of the translucent cover 10 to the fitting hole 46, the support part 40 can be mounted in the translucent cover 10.

Assembly of the light source device 100 of the present embodiment may be performed in the following manner. In the state in which the substrate 21 with the light source 22 mounted thereon and the placing part 32 of the placing plate 30 abut each other, the placing plate 30 is inserted into the space surrounded by the side plate abutting plate 42, the fitting plate 43 and the partition plate 44 of the support part 40 from an end of the support part 40 in the longitudinal direction thereof. In this case, the bent part 311 of the placing plate 30 is fitted between the side plate abutting plate 42 and the partition plate 44, and the side plate 31 of the placing plate 30 abuts the side plate abutting plate 42 of the support part 40 to be positioned thereto. Herein, movement of the placing plate 30 is limited by the support part 40 in any direction of the top, bottom, left and right thereof, and thereby the placing plate 30 is reliably fixed to the support part 40.

When the placing plate 30 is fixed to the support part 40, the substrate 21 is fitted between the placing plate 30 and the fitting plate 43, so that the substrate 21 is also fixed to the placing plate 30. That is, since the light source 22 can be exposed through the opening 45, and the substrate 21 can be fitted between the placing part 32 of the placing plate 30 and the fitting plate 43 of the support part 40, it is also possible to fix the substrate 21 to the placing plate 30 while fixing the placing plate 30 thereto. Further, the wirings connected to the substrate 21 can pass inside of the support part 40 through the wiring hole 321 of the placing plate 30.

The support part 40 to which the substrate 21 and the placing plate 30 are fixed is inserted from the end of the translucent cover 10. In this case, with the fitting hole 46 being fitted to the protrusion 12 by positioning the protrusion 12 and the fitting hole 46, it is possible to slide the curved plate 41 in the longitudinal direction of the translucent cover 10.

When the support part 40 to which the substrate 21 and the placing plate 30 are fixed is mounted in the translucent cover 10, the wirings connected to the substrate 21 are connected to terminals of the bases 1 and 2, and the bases 1 and 2 and the translucent cover 10 are connected with each other, so that the light source device 100 can be assembled. As described above, with the fitting hole 46 being fitted to the protrusion 12, only by sliding the curved plate 41 in the longitudinal direction of the translucent cover 10, the support part 40 can be mounted in the translucent cover 10, and the light source device 100 can be easily assembled.

As described above, the placing part 32 (for example, abutting surface) of the placing plate 30 for the substrate 21 is disposed on the center side C of the translucent cover 10 from the side part (for example, the bent part 311 of the side plate 31) of the placing plate 30 supported by the support part 40. That is, since the placing part 32 of the placing plate 30 is disposed on the center side C of the translucent cover 10 from the side part of the placing plate 30 supported by the support part 40 mounted in the translucent cover 10, the placing part 32 of the placing plate 30 can be disposed on the center side away from the inner surface 11 of the translucent cover 10. Further, since a gap between the inner surface 11 of the translucent cover 10 (for example, a portion in which the protrusion 12 is provided or around the portion) and the placing plate 30 can be increased, it becomes difficult to transmit heat from the placing plate 30 to the inner surface 11 of the translucent cover 10 (for example, a portion abutting the curved plate 41). Therefore, a difference in the temperature rise between a portion of the translucent cover 10 in which the placing plate 30 and the substrate 21 are disposed (a portion illustrated by a letter E in FIG. 2) and a portion other than the portion (for example, a portion on a side opposite to the portion with respect to the center side C of the translucent cover 10, that is, a portion illustrated by a letter F in FIG. 2) is reduced, and the temperature rise of the translucent cover 10 can be suppressed from becoming non-uniform, and thereby it is possible to prevent the occurrence of warping in the translucent cover 10.

In addition, as illustrated in FIG. 2, by disposing the placing part 32 for the substrate 21 having the light source 22 mounted on one surface thereof to the center side C of the translucent cover 10 from the side part (for example, the bent part 311 of the side plate 31) of the placing plate 30 supported by the support part 40, light emitted from the light source 22 to a direction parallel to one surface of the substrate 21 or to a rear from the substrate 21 (a side opposite to a surface of the substrate 21 on which the light source 22 is mounted) is not obstructed, so that the light can be efficiently emitted from the translucent cover 10 to the outside, and light distribution can be expanded.

In addition, the support part 40 is mounted in the translucent cover 10, and supports the placing plate 30 so as to provide a gap between the placing plate 30 and the translucent cover 10. Then, the central portion of the support part 40 in which the light source 22 is located protrudes in the central direction of the translucent cover 10 with respect to the both end parts (the side plate abutting plates 42). That is, by disposing the fitting plates 43 of the support part 40 (the central portion in which the light source 22 is located) to the center side C of the translucent cover 10 from the side plate abutting plates 42, the fitting plates 43 can be disposed on the center side away from the inner surface 11 of the translucent cover 10, and the gap between the inner surface 11 of the translucent cover 10 (for example, a portion in which the protrusion 12 is provided or around the portion) and the fitting plate 43 can be increased, so that it becomes difficult to transmit the heat from the placing plate 30 to the inner surface 11 of the translucent cover 10 (for example, the portion abutting the curved plate 41). Therefore, a difference in the temperature rise between the portion of the translucent cover 10 in which the placing plate 30 and the substrate 21 are disposed (the portion illustrated by the letter E in FIG. 2) and the portion other than the portion (for example, the portion on a side opposite to the portion with respect to the center side C of the translucent cover 10, that is, the portion illustrated by the letter F in FIG. 2) is reduced, and the temperature rise of the translucent cover 10 can be suppressed from becoming non-uniform, and thereby it is possible to prevent the occurrence of warping in the translucent cover 10. In addition, by disposing the fitting plates 43 of the support part 40 (the central portion in which the light source 22 is located) to the center side C of the translucent cover 10 from the side plate abutting plates 42, light emitted from the light source 22 to the direction parallel to one surface of the substrate 21 or to the rear from the substrate 21 (the side opposite to the surface of the substrate 21 on which the light source 22 is mounted) is not obstructed, so that the light can be efficiently emitted from the translucent cover 10 to the outside, and light distribution can be expanded.

In addition, as illustrated in FIG. 2, the support part 40 supports the side plate 31 so that the placing part 32 is disposed on the center side C of the translucent cover 10 from the side plate 31. By providing the side plate 31 inclined with respect to the placing part 32, the placing part 32 can be lifted (approached) to the center side C of the translucent cover 10 to an extent equivalent to the side plate 31, and the placing part 32 can be disposed on the center side away from the inner surface 11 of the translucent cover 10 (for example, a portion in which the protrusion 12 is provided or around the portion). Therefore, the gap between the inner surface 11 of the translucent cover 10 and the placing plate 30 can be increased, and thereby, it becomes difficult to transmit heat from the placing plate 30 to the inner surface 11 of the translucent cover 10 (for example, the portion abutting the curved plate 41).

In addition, as illustrated in FIG. 2, the side plate abutting plate 42 of the support part 40 abuts the side plate 31 of the placing plate 30, and the side plate 31 of the placing plate 30 is fitted to the support part 40 in such a manner that the side plate 31 (specifically, the bent parts 311) is pinched by the side plate abutting plates 42 and the partition plate 44. Thereby, the placing plate 30 can be fixed in a required arrangement state in the translucent cover 10.

In addition, as illustrated in FIG. 2, the partition plate 44 separates the space between the placing plate 30 and the curved plate 41 into the plurality of spaces (two spaces in the example of FIG. 2). That is, since the space between the placing plate 30 and the curved plate 41 abutting the inner surface 11 of the translucent cover 10 is separated into two spaces S1 and S2 by the partition plate 44, and at least two air layers S1 and S2 are formed between the placing plate 30 and the translucent cover 10, it becomes difficult to transmit the heat from the placing plate 30 to the translucent cover 10. Therefore, a difference in the temperature rise between the portion of the translucent cover 10 in which the placing plate 30 and the substrate 21 are disposed (for example, the portion abutting the curved plate 41) and a portion other than the portion (for example, the portion on the side opposite to the portion with respect to the center side C of the translucent cover 10, that is, the portion illustrated by a letter F in FIG. 2) is reduced, and the temperature of the translucent cover 10 can be uniformly increased, and thereby it is more possible to prevent the occurrence of warping in the translucent cover 10.

In addition, the translucent cover 10 is provided with the narrow portions 13 formed on the protrusion 12 for pinching around the fitting hole 46 of the curved plate 41 with the inner surface 11 thereof. Since the curved plate 41 is pinched by the narrow portions 13 and the inner surface 11, the support part 40 can be more reliably mounted in the translucent cover 10. Further, since the support part 40 and the translucent cover 10 are slidably fitted to each other at one place, assembly of the light source device is facilitated. In addition, since the fitting hole 46 and the protrusion 12 are located on a side opposite to a light emitting direction of the light source 22, the light from the light source 22 is not shielded by a member for mounting the support part 40 in the translucent cover 10.

In addition, the support part 40 is made of a synthetic resin, and supports the placing plate 30 apart from the translucent cover 10. Since the placing plate 30 is separated without being closely contacted with the translucent cover 10, it can be difficult to transmit the heat from the placing plate 30 to the translucent cover 10. In addition, by making the support part 40 of the synthetic resin, it can be difficult to transmit the heat from the placing plate 30 to the translucent cover 10, and thereby the temperature of the translucent cover 10 can be uniformly increased.

Further, when assembling the light source device 100, by using the above-described fitting mechanism, a member such as a rivet, a screw, or the like is not required, and assembly performance can be improved.

In the above-described embodiment, by making the support part 40 using highly reflective PBT, when light emitted from the light source 22 is reflected by the inner surface 11 of the translucent cover 10, and the reflected light is incident on the side plate abutting plate 42 or the fitting plate 43 of the support part 40, the light can be emitted to an outside from the translucent cover 10 by further reflecting the incident light by the side plate abutting plate 42 or the fitting plate 43. Thereby, it is possible to improve the optical performance such as luminous efficiency of the light source device 100, or the like by reusing the reflected light in the translucent cover 10. In addition, the support part 40 also serves as a role of reflection member, so that a separate member such as a reflection plate (reflector), or the like is not required, and since an attaching process of the reflection plate is also not required, product costs and assembling costs can be reduced, and the assembly performance can be improved.

### Embodiment 2

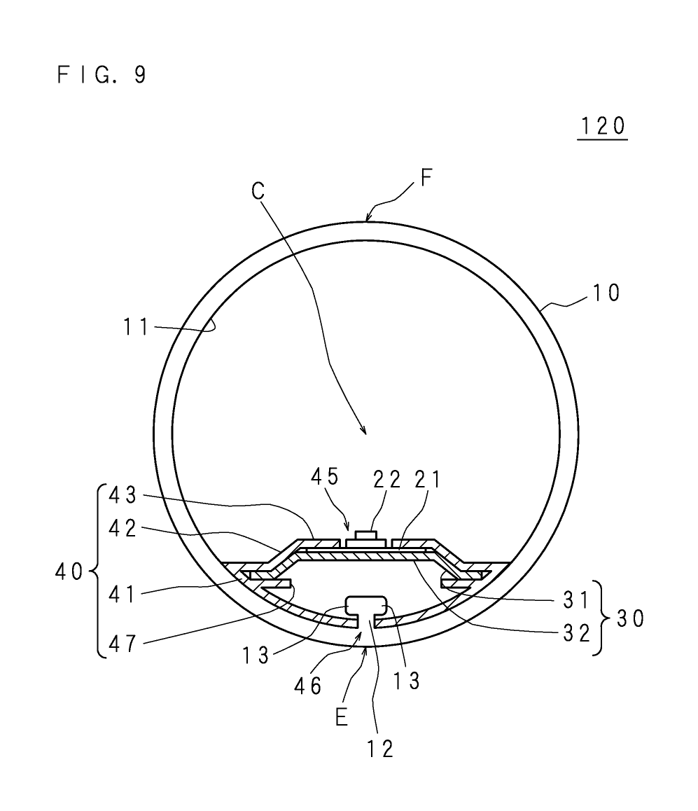

FIG. 9 is a cross-sectional view illustrating an example of a configuration of a light source device 120 of Embodiment 2. Embodiment 1 has the configuration in which the partition plate 44 is bridged between the opposite end parts of the curved plate 41, however, the light source device 120 of Embodiment 2 includes fitting plates 47 instead of the partition plate 44. As illustrated in FIG. 9, the fitting plates 47 are provided with such a gap that only the side plate 31 (specifically, the bent part 311) of the placing plate 30 is fitted with the side plate abutting plates 42, without applying a structure for bridging the opposite end parts of the curved plate 41. In this case, it is possible to reduce the material required when manufacturing the support part 40 by extrusion molding, and reduce the weight of the light source device 120.

### Embodiment 3

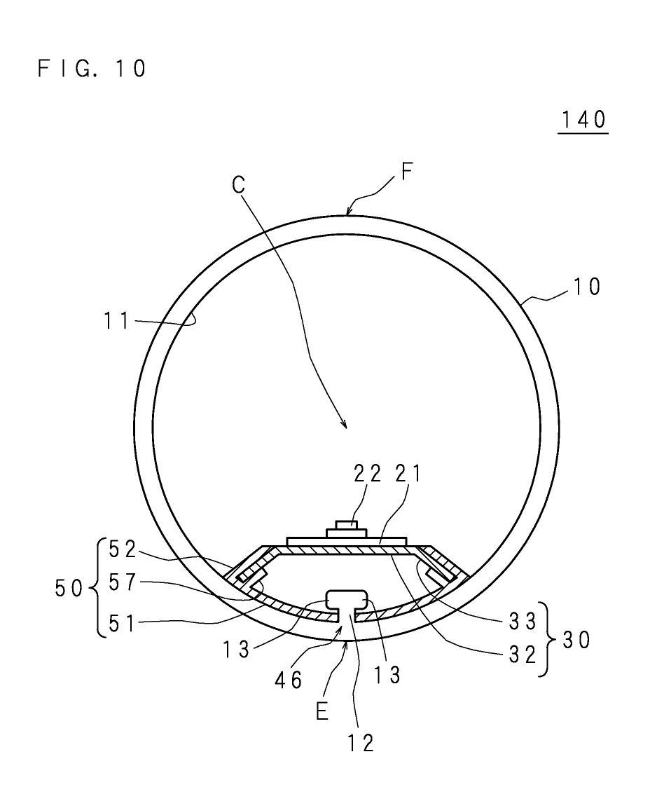

FIG. 10 is a cross-sectional view illustrating an example of a configuration of a light source device 140 of Embodiment 3. Embodiment 3 does not include the element corresponding to the bent part 311 of the placing plate 30 and the fitting plate 43 of the support part 40 of Embodiment 1.

As illustrated in FIG. 10, a placing plate 30 includes a placing part 32 abutting the substrate 21, and side plates 33 slantly extending from the long sides of the placing part 32.

In addition, a support part 50 includes a curved plate 51 which abuts the inner surface 11 of the translucent cover 10, side plate abutting plates 52 which extend from the curved plate 51 and abut the side plates 33 of the placing plate 30, and fitting plates 57 which are configured to fit the side plates 33 of the placing plate 30 with the side plate abutting plates 52. In addition, it is possible to apply a partition plate for separating a space between the placing plate 30 and the curved plate 51 instead of the fitting plates 57.

The placing plate 30 can be fixed to the support part 50 by fitting the side plates 33 of the placing plate 30 between the side plate abutting plates 52 and the fitting plates 57. In addition, the substrate 21 can be fixed to the placing plate 30 by an adhesive, for example.

In the light source device 140 of Embodiment 3, since a mounting surface of the substrate 21 on which the light source 22 is mounted is not covered with the support part, for example, even when the dimension of the light source 22 is small, and light emitted from the light source 22 proceeds on the mounting surface of the substrate 21, the light is not blocked. Therefore, it is possible to efficiently extract the light from the light source 22, and also expand the light distribution.

In addition, the support part 50 is mounted in the translucent cover 10, and supports the placing plate 30 so as to provide a gap between the placing plate 30 and the translucent cover 10. Herein, the placing plate 30 is supported by the support part 50 so that the placing part 32 for the substrate 21 protrudes in the central direction of the translucent cover 10 with respect to the side parts (for example, the side plates 33) extending from the end parts of the placing part 32.

Thereby, since the gap between the inner surface 11 of the translucent cover 10 (for example, a portion in which the protrusion 12 is provided or around the portion) and the placing plate 30 (specifically, the placing part 32) can be increased, it becomes difficult to transmit heat from the placing plate 30 to the inner surface 11 of the translucent cover 10 (for example, a portion abutting the curved plate 51). Therefore, a difference in the temperature rise between a portion of the translucent cover 10 in which the placing plate 30 and the substrate 21 are disposed (a portion illustrated by a letter E in FIG. 10) and a portion other than the portion (for example, a portion on a side opposite to the portion with respect to the center side C of the translucent cover 10, that is, a portion illustrated by a letter F in FIG. 10) is reduced, and the temperature rise of the translucent cover 10 can be suppressed from becoming non-uniform, and thereby it is possible to prevent the occurrence of warping in the translucent cover 10.

In addition, as illustrated in FIG. 10, by disposing the placing part 32 for the substrate 21 having the light source 22 mounted on one surface thereof to the center side C of the translucent cover 10 from the side part (for example, the side plate 33) of the placing plate 30 supported by the support part 50, light emitted from the light source 22 to the direction parallel to one surface of the substrate 21 or to the rear from the substrate 21 (the side opposite to the surface of the substrate 21 on which the light source 22 is mounted) is not obstructed, so that the light can be efficiently emitted from the translucent cover 10 to the outside, and light distribution can be expanded.

### Embodiment 4

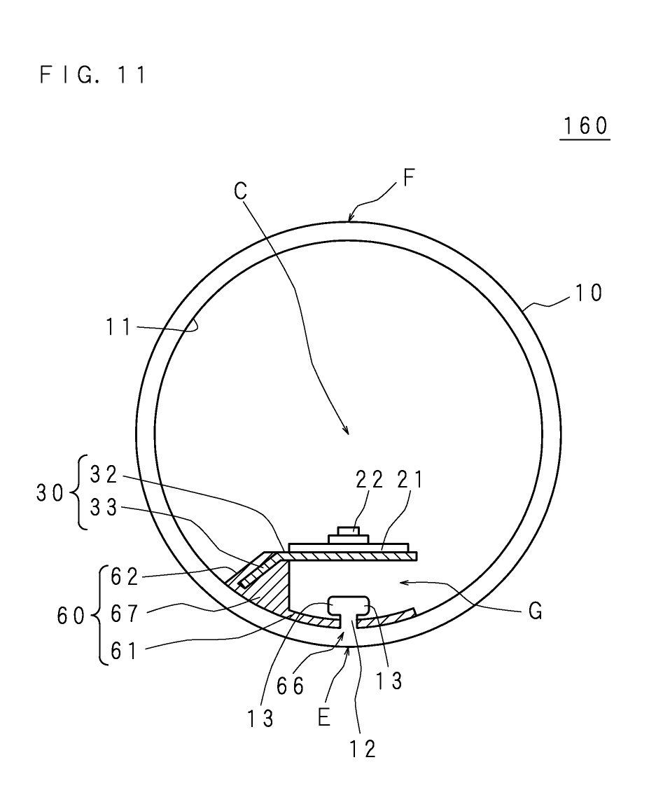

FIG. 11 is a cross-sectional view illustrating an example of a configuration of a light source device 160 of Embodiment 4. Embodiment 1 has a configuration in which the support part 40 supports the both side parts of the placing plate 30, however, the light source device 160 of Embodiment 4 has a configuration in which a support part 60 supports only one side part of a placing plate 30.

As illustrated in FIG. 11, the placing plate 30 includes a placing part 32 abutting the substrate 21, and a side plate 33 slantly extending from only one long side of the placing part 32.

In addition, a support part 60 includes a curved plate 61 which abuts the inner surface 11 of the translucent cover 10, a side plate abutting plate 62 which extends from one end part of the curved plate 61 and abuts the side plate 33 of the placing plate 30, and a fitting part 67 which is configured to fit the side plate 33 of the placing plate 30 with the side plate abutting plate 62. Since the support part 60 is configured to support only one side part of the placing plate 30, in order to provide strength, the thickness of the fitting part 67 may be increased, as illustrated in FIG. 11.

In the light source device 160 of Embodiment 4, since only one side of the placing plate 30 is supported, as illustrated in FIG. 11, it is possible to communicate through a gap G a space surrounded by the placing plate 30, the curved plate 61, and the fitting part 67 with a space of the center side C of the translucent cover 10. Thereby, there is no member for blocking the space in the translucent cover 10, and air in the translucent cover 10 can freely move in the translucent cover 10. Therefore, temperature distribution in the translucent cover 10 becomes uniform due to airflow, and a temperature difference between a portion indicated by a letter E and a portion indicated by a letter F of the translucent cover 10 can be decreased.

The above-described embodiments have a configuration using the LED module as a light source, however, the light source is not limited to the LED module, and a light source such as an organic EL display may be used.

It is to be noted that the disclosed embodiment is illustrative and not restrictive in all aspects. The scope of the present invention is defined by the appended claims rather than by the description preceding them, and all changes that fall within metes and bounds of the claims, or equivalence of such metes and bounds thereof are therefore intended to be embraced by the claims.

1-5. (canceled)

6. A light source device, comprising:
a substrate with a light source mounted thereon;
a placing plate on which the substrate is placed;
a cylindrical translucent cover in which the substrate and the placing plate are disposed; and
a support part which is mounted in the translucent cover, and supports the placing plate so as to provide a gap between the placing plate and the translucent cover,
wherein the support part is configured such that a central portion thereof on which the light source is located protrudes in a central direction of the translucent cover with respect to both end parts thereof, and
wherein the support part has a curved plate located at an inner side of the translucent cover, and a partition plate which separates a space between the curved plate and the placing plate.

7. The light source device according to claim 6,
wherein the placing plate has a placing part on which the substrate is placed, and side parts which extend from end parts of the placing part, and
wherein the support part supports the side parts by both end parts thereof.

8. The light source device according to claim 6,
wherein the translucent cover includes a protrusion disposed on an inner surface thereof in a longitudinal direction of the translucent cover, and
wherein the curved plate has a fitting hole to which the protrusion is fitted.

9. A light source device, comprising:
a substrate with a light source mounted thereon;
a placing plate on which the substrate is placed;
a cylindrical translucent cover in which the substrate and the placing plate are disposed; and
a support part which is mounted in the translucent cover, and supports the placing plate so as to provide a gap between the placing plate and the translucent cover,
wherein the placing plate is supported by the support part so that a placing part for the substrate protrudes in a central direction of the translucent cover with respect to side parts extending from end parts of the placing part, and
wherein the support part has a curved plate located at an inner side of the translucent cover, and a partition plate which separates a space between the curved plate and the placing plate.

10. The light source device according to claim 9,
wherein the translucent cover includes a protrusion disposed on an inner surface thereof in a longitudinal direction of the translucent cover, and
wherein the curved plate has a fitting hole to which the protrusion is fitted.
